(19) United States
(12) Patent Application Publication
(10) Pub. No.: US 2020/0245695 A1
(43) Pub. Date: Aug. 6, 2020

(54) VAPORIZATION DEVICE HAVING A WICK AND COIL ASSEMBLY

(71) Applicant: AVANZATO TECHNOLOGY CORP., Chicago, IL (US)

(72) Inventor: Thomas Fornarelli, Chicago, IL (US)

(21) Appl. No.: 16/266,106

(22) Filed: Feb. 3, 2019

(51) Int. Cl. A24F 47/00; H05B 1/02; H05B 3/46; A24F 7/02

(52) U.S. Cl. CPC A24F 47/008; A24F 7/02; H05B 3/46; H05B 1/0297

(57) ABSTRACT

A vaporization device includes a wick and coil assembly comprising a plurality of coils disposed on a ceramic support member, and an e-liquid reservoir comprising an annular configuration that narrows radially at a longitudinal end thereof to define an annular aperture that provides fluid communication between the reservoir and the wick and coil assembly.

### FIELD OF THE INVENTION

The present invention relates to vaporization devices. More specifically, the present invention relates to a vaporization device having a bottom flow tank and a wick and coil assembly.

### BACKGROUND

Vaporization devices, commonly referred to a e-cigs, vapes, vaping devices, and vaporizers typically feature a reservoir for a vaporizable liquid (an e-liquid reservoir) that supplies the e-liquid to a vaporization chamber via a wick or other means. When a user draws or inhales on the vaporization device a coil or heating element in the vaporization chamber and in contact with or near the wick vaporizes the e-liquid, which is subsequently inhaled by the user.

The increasing popularity of vaporization devices is due in part to an increase in the variety of e-liquids that are available. Typical e-liquids contain one or more oils or plant extracts, water, and flavorings. Different e-liquids may vaporize at different temperatures and different oils within an e-liquid may vaporize at different temperatures. Vaporization devices work best when the e-liquid is consistently delivered to a vaporization chamber having a heating element that heats the e-liquid and/or the components thereof to their optimal vaporization temperatures.

However, problems associated with flow of the e-liquid to the vaporization chamber can result in a wick that dries out or is overheated by the heating element. For example, the heating element may be too hot or oriented in such a way as to heat portions of the wick that are insufficiently wetted by the e-liquid. Consequently, the heating element may burn the e-liquid, which not only causes a poor taste but also can degrade the chemical composition of the e-liquid.

Such problems associated with the flow of the e-liquid can be caused by the reservoir being shaped so that the e-liquid is not adequately directed at the wick. Therefore, a need exists for an e-liquid reservoir shaped to direct e-liquid to a wick and coil assembly that is oriented to effectively deliver e-liquid to the coil without drying or overheating the wick. Further, a need exists for the wick and coil assembly to have a multi-stage coil that heats different portions of the wick and coil assembly to different temperatures such that more saturated portions of the wick and coil assembly are heated more than less saturated portions, or to accommodate mixtures of oils within the e-liquid having different vaporization temperatures.

### SUMMARY OF THE INVENTION

According to one aspect of the invention, a vaporization device comprises an e-liquid reservoir and a wick and coil assembly in fluid communication with the e-liquid reservoir. According to another aspect of the invention, a vaporization device comprises a wick and coil assembly and an e-liquid reservoir comprising an annular configuration that narrows radially at a longitudinal end thereof to define an annular aperture that provides fluid communication between the reservoir and the wick and coil assembly.

According to a further aspect of the invention, a vaporization device comprises a wick and coil assembly comprising a plurality of coils disposed on a ceramic support member, and an e-liquid reservoir comprising an annular configuration that narrows radially at a longitudinal end thereof to define an annular aperture that provides fluid communication between the reservoir and the wick and coil assembly.

### BRIEF DESCRIPTION OF THE DRAWINGS

FIG. 1 is an external side view of a first embodiment of a vaporization device;

FIG. 2 is an external top view of the first embodiment of the vaporization device;

FIG. 3 is a longitudinal cross-sectional view of the first embodiment of the vaporization device;

FIG. 4 is an enlarged longitudinal cross-sectional view of a first portion of the first embodiment of the vaporization device;

FIG. 5 is an enlarged longitudinal cross-sectional view of a second portion of the first embodiment of the vaporization device;

FIG. 6 is an enlarged longitudinal cross-sectional view of a third portion of the first embodiment of the vaporization device;

FIG. 7 is an external side view of a second embodiment of the vaporization device;

FIG. 8 is an external top view of the second embodiment of the vaporization device;

FIG. 9 is a longitudinal cross-sectional view of the second embodiment of the vaporization device; and

FIG. 10 is an enlarged longitudinal cross-sectional view of a second portion of the second embodiment of the vaporization device.

Other aspects and advantages of the present invention will become apparent upon consideration of the following detailed description, wherein similar structures have similar reference numerals.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

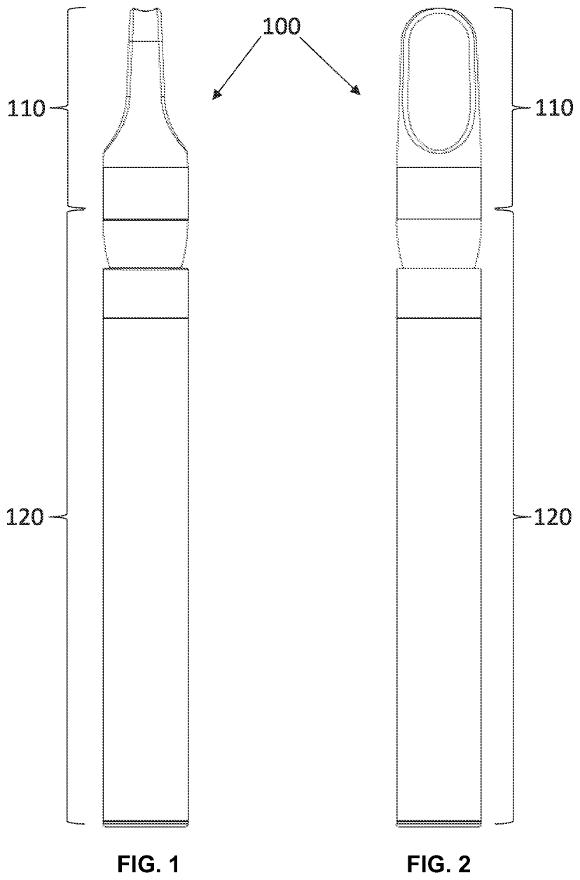

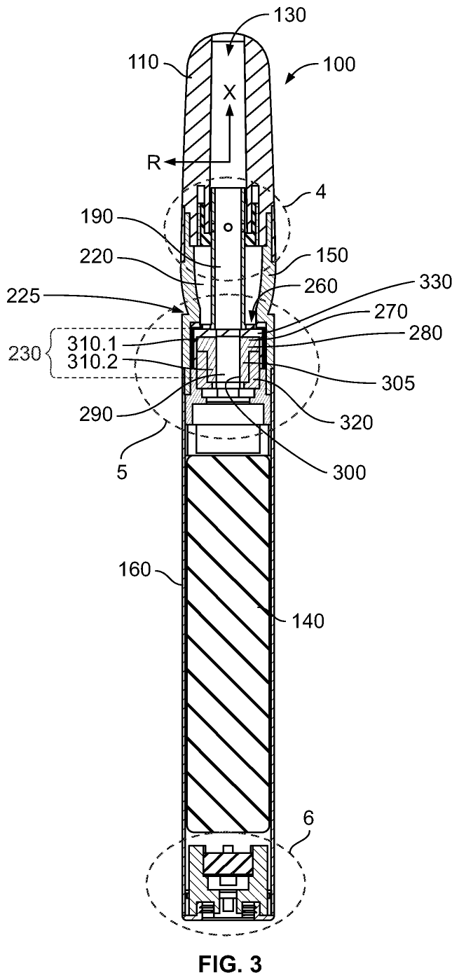

A first embodiment of a vaporization device 100 of the present invention is shown in FIGS. 1 and 2. Externally viewed, the vaporization device 100 comprises a mouthpiece 110 attached to an end of a body 120. The mouthpiece 110 includes an aperture 130 (see FIG. 3) therethrough for a user to draw on the vaporization device 100. The aperture 130 is fluidly connected to an interior volume of a vent tube 190 shown in FIGS. 3-5. Additional apertures (not shown) are disposed elsewhere on the body 120 to allow ambient air to enter the body 120 in response to the user's draw.

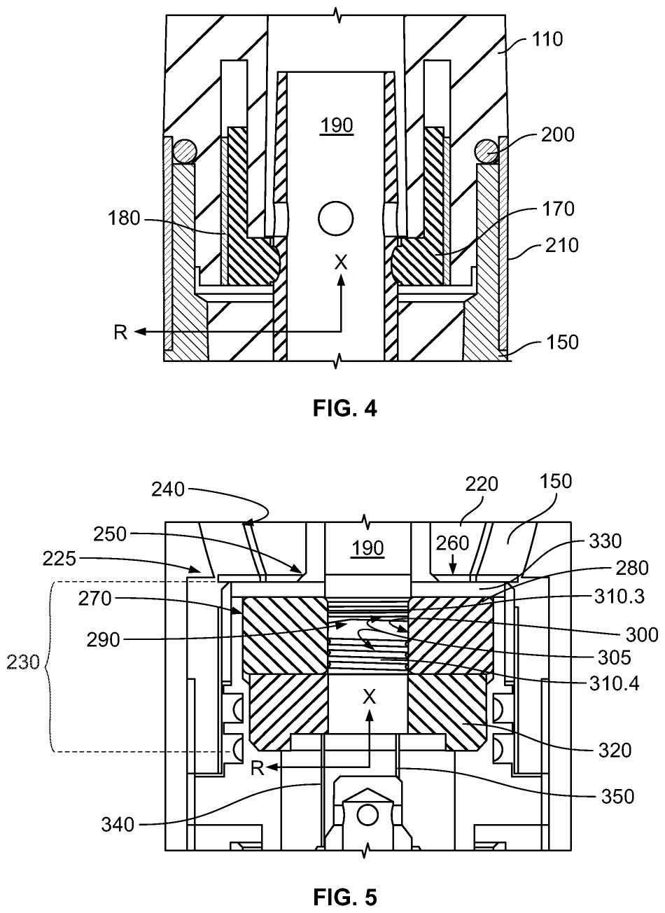

Referring to FIG. 3, in cross-section additional components of the first embodiment of the vaporization device 100 are visible. A battery 140 is disposed within a battery body 160. A first portion of the vaporization device 100 shown within the dashed ellipse 4 includes a first attachment region between the mouthpiece 110 and a tank body 150. A second portion of the vaporization device 100 shown within the dashed ellipse 5 includes a wick and coil assembly 230 and a second attachment region between the tank body 150 and the battery body 160. A third portion of the vaporization device 100 shown within the dashed ellipse 6 includes components disposed within the battery body 160 on a bottom side of the battery 140. Portions of the vaporization device 100 within the dashed ellipses 4, 5, and 6 are further described below with regard to FIGS. 4, 5, and 6. For clarity of description several of the figures are labeled with axial and radial axes, denoted as X and R, respectively. Air flows through the vaporization device 100 from the bottom to the top in FIG. 3.

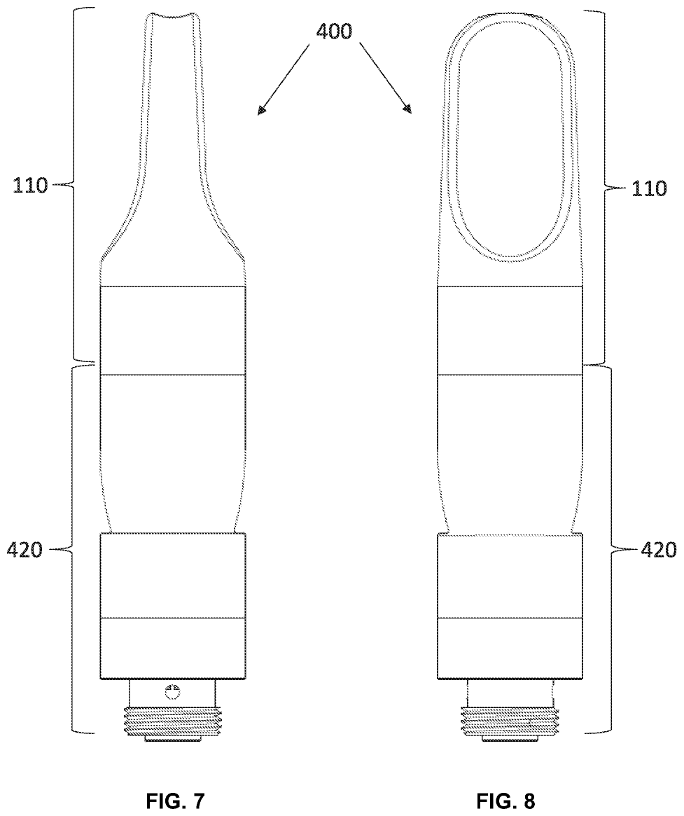

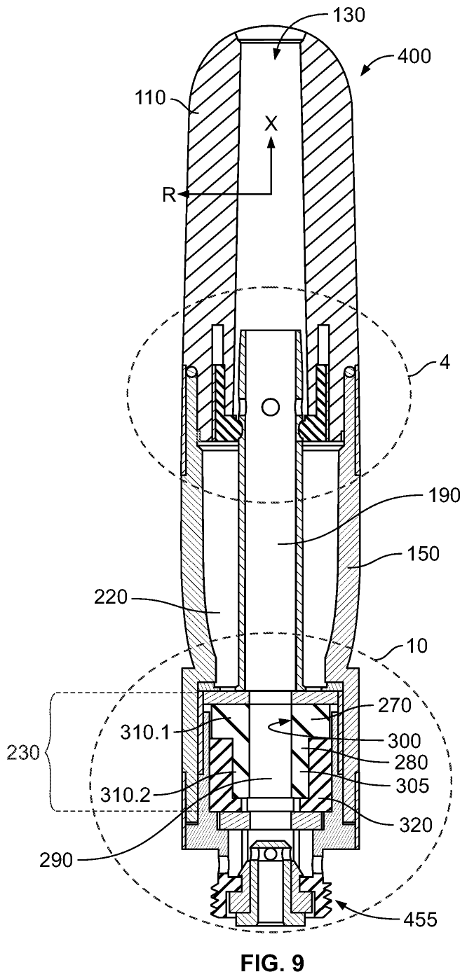

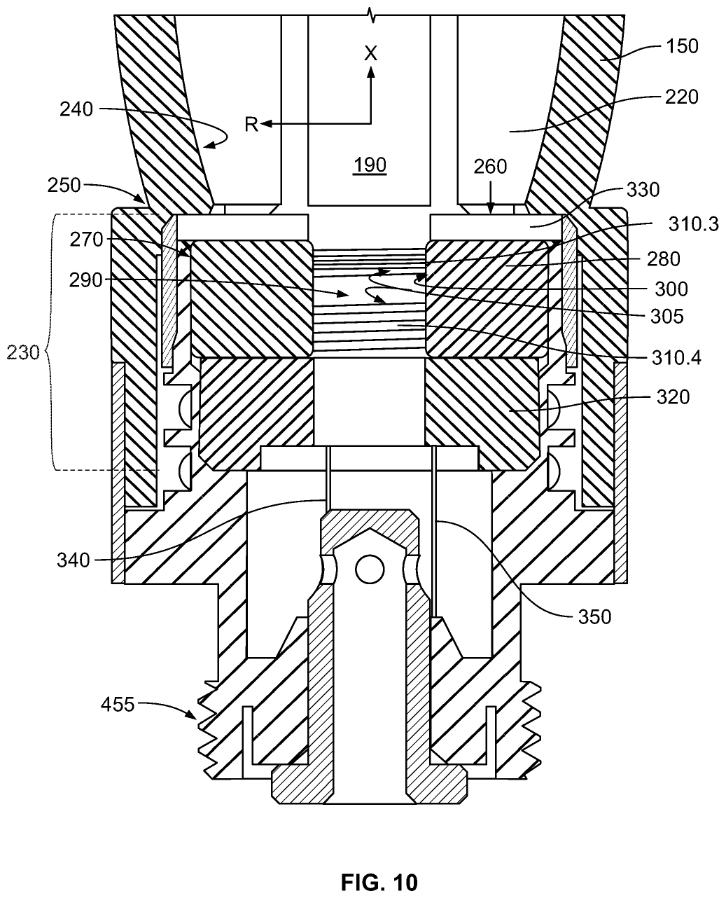

Referring to FIGS. 1-6, in this embodiment of the vaporization device 100 the battery body 160 and the tank body 150 are permanently attached by any suitable method of attachment as known in the art, for example without limitation, by a press or interference fit, or a permanent adhesive. The battery 140 in this embodiment may be rechargeable or the battery 140 may be a single use disposable battery. In other embodiments, for example vaporization device 400 described more fully hereinbelow with regard to FIGS. 7-10, a battery body otherwise similar to the battery body 160 detachably attaches to a tank body 450, for example, via threads that engage with threads 455 shown in FIGS. 9 and 10.

Referring to FIG. 4, the mouthpiece 110 attaches into a top end of the tank body 150. Preferably the mouthpiece 110 removably attaches to the tank body 150 by a press fit making it easy to put onto and take off from the tank body 150, but any other suitable method of attachment, removable or permanent, as known in the art may also be used. In one embodiment, an annular mouthpiece seal ring 170 is disposed within an inner fixing tube 180 so that when assembled the mouthpiece seal ring 170 compresses to form a seal against an outer surface of a vent tube 190. A mouthpiece O-ring 200 seals the mouthpiece 110 against a top end of the tank body 150. In some embodiments, a top decorating ring 210 can be disposed over the first attachment region.

Referring to FIGS. 3 and 5, an e-liquid reservoir 220 is defined between the tank body 150 and the vent tube 190. The e-liquid reservoir 220 has an annular configuration disposed generally around the longitudinal axis X. Annular reservoirs are known in the art, for example, as disclosed in U.S. Ser. No. 16/182,574 (Dual Chamber Vaporization Tank), filed on Nov. 6, 2018, and hereby incorporated by reference herein in its entirety. However, the annulus of the reservoir 220 has a particularly advantageous shape at one end. The annulus of the reservoir 220 narrows radially at a longitudinal end 225 of the reservoir 220. In one embodiment, the narrowing of the annulus of the reservoir 220 is achieved by the radius of an interior surface 240 (see FIG. 5) of the tank wall 150 becoming smaller at the longitudinal end 225. In other embodiments, the narrowing of the annulus of the reservoir 220 is achieved by the radius of an exterior surface 250 (see FIG. 5) of the vent tube 190 becoming larger at the longitudinal end 225. In other embodiments both the radius of the interior surface 240 of the tank wall 150 becomes smaller and the radius of an exterior surface 250 of the vent tube 190 becomes larger at the longitudinal end 225 to affect a narrowing of the annulus of the reservoir 220.

An annular aperture 260 through the longitudinal end 225 of the reservoir 220 is defined by the interior surface 240 and the exterior surface 250. The annular aperture 260 provides fluid communication between the reservoir 220 and a wick and coil assembly 230. The narrowing of the reservoir 220 at the aperture 260 provides a directed path for the e-liquid from the reservoir 220 to the wick and coil assembly 230. Such directed flow of the e-liquid can help to alleviate problems of uneven e-liquid vaporization or wick over heating that may be caused if the e-liquid is not adequately directed at the wick and coil assembly 230.

Still referring to FIGS. 3 and 5, the wick and coil assembly 230 is illustrated in one embodiment in FIG. 3 and shown in another embodiment in FIG. 5. In both embodiments the wick and coil assembly 230 comprises a ceramic support member 270 disposed on a sealing sleeve 320. In both embodiments of the wick and coil assembly 230 shown in FIGS. 3 and 5 the ceramic support member 270 has an annular body 280 defining an interior volume 290 and having an inner surface 300. The interior volume 290 is in fluid communication with the interior volume of the vent tube 190, which is in fluid communication with the aperture 130 through the mouthpiece 110. The ceramic support member 270 and the annular body 280 are made from a ceramic material that is porous to the e-liquid supplied by directed flow from the reservoir 220 through the aperture 260. The e-liquid passes through the pores of the annular body 280 upon wetting a surface thereof.

A single coil 305 or a plurality of wire coils 310 are fixed to or embedded onto the inner surface 300 and/or into the ceramic body 280 and exposed at the inner surface 300. The process for embedding the single coil 305 or the plurality of coils 310 onto the inner surface and/or into the ceramic body 280 in one embodiment starts with wrapping the coil 305 or the plurality of coils 310 around a mold core of a mold having an annular cavity. Ceramic material is then extruded or otherwise pushed into the mold and allowed to harden. Upon removal of the mold, the coil 305 or the plurality of coils 310 are embedded onto the inner surface 300 and/or into the ceramic body 280 and exposed at the inner surface 300. The process described above is just one way to embed the coil 305 or the plurality of coils 310 onto the inner surface 300 and/or into the ceramic body 280; any suitable method for fixing or embedding a metal coil onto a surface of a ceramic body and/or into a ceramic body without limitation as known in the art may be employed.

In the embodiment shown in FIG. 3, the plurality of coils 310 are represented by a first coil 310.1 and a second coil 310.2. Although only two coils are illustrated, any number of coils can be utilized. The first coil 310.1 is shown to have a larger coil radius than the second coil 310.2. This is represented by the structure labeled 310.1 having a larger radius than the structure labeled 310.2. In another embodiment the single coil 305 can have the larger coil radius of the first coil 310.1 or the smaller coil radius of the second coil 310.2, or include both the larger coil radius of the first coil 310.1 and the smaller coil radius of the second coil 310.2.

In the embodiment shown in FIG. 5 the plurality of coils 310 are represented by a first coil 310.3 and a second coil 310.4. Again, although only two coils are illustrated, any number of coils can be utilized. The first coil 310.3 is shown to have a smaller wire radius than the second coil 310.4. In another embodiment the single coil 305 can have the larger wire radius of the second coil 310.4 or the smaller wire radius of the first coil 310.3, or include both the larger wire radius of the second coil 310.4 and the smaller wire radius of the first coil 310.3.

In one embodiment each of the coils 310.1, 310.2, etc. of the embodiment shown in FIG. 3 or each of the coils 310.3, 310.4, etc. of the embodiment shown in FIG. 5 has a different electrical resistance. This can be achieved, for example in the embodiment shown in FIG. 5, by making the individual coils 310.3, 310.4. etc., out of different materials, or with different wire radii, or a combination of different materials and different wire radii. In the embodiment shown in FIG. 3 each of the coils can be given a different electrical resistance, for example, by making the individual coils 310.1, 310.2, etc. of different coil radii (and therefore different lengths), out of different materials, or a combination of different coil radii and different materials. In yet another embodiment the individual coils 310.1, 310.2, etc. of the embodiment shown in FIG. 3 or the individual coils 310.3, 310.4, etc. of the embodiment shown in FIG. 5 could be given a different electrical resistance by a combination of different coil radii, different wire radii, and/or different materials.

The individual coils 310.1, 310.2, etc. or 310.3, 310.4, etc. of the plurality of coils 310 are configured in an electrical circuit in parallel with a common voltage source, for example a battery. As is well known, the plurality of coils 310 having different resistances and configured in parallel with a common voltage would produce a plurality of current levels and a corresponding plurality of heating temperatures.

As visible in FIGS. 3 and 5, in one embodiment between the ceramic support member 270 and the aperture 260 is disposed a layer of absorbent material 330, for example without limitation, cotton. In operation, the absorbent material 330 becomes saturated with the e-liquid from the reservoir 220 and provides fluid communication between the aperture 260 of the reservoir 220 and a top surface of the ceramic support member 270. In other embodiments not shown, the layer of absorbent material 330 may extend beyond the top surface of the ceramic support member 270 to cover another portion of the ceramic body 280, either on the inner surface 300 or on a different surface.

As mentioned above, the ceramic material of the ceramic support member 270 is porous. The porous ceramic material acts as a wick to draw e-liquid into it. The e-liquid passes through the annular body 280 of the ceramic support member 270 and reaches the plurality of coils 310, where it is vaporized. The vaporized e-liquid flows into the interior volume 290 and is entrained into air flowing through the vaporization device from the ambient ultimately to be inhaled by the user. Sealing sleeve 320 provides a seal between a bottom of the ceramic support member 270, the battery body 160, and the battery 140.

In one embodiment, the battery 140 is electrically connected to the plurality of coils 310 and includes additional circuitry that controls the supply of power to the plurality of coils. For example without limitation, the additional circuitry connects to the plurality of coils 310 via wires 340, 350 shown in FIG. 5.

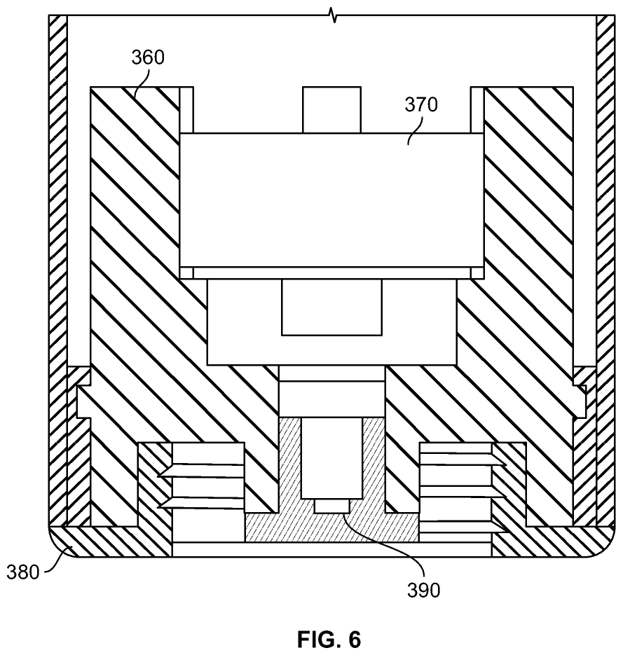

Referring to FIG. 6, in one embodiment a portion of the additional circuitry is disposed beyond a bottom end of the battery 140. The portion of the vaporization device 100 shown in FIG. 6 is in fluid communication with the interior volume 290 via an annular space around the battery 140. The interior volume 290 in turn is in fluid communication with the interior volume of the vent tube 190, which is in fluid communication with the aperture 130 through the mouthpiece 110.

A sensor holder 360 supports a sensor 370, for example without limitation, a pressure sensor, an air flow sensor, or any other sensor suitable for determining when a user is drawing vacuum on the mouthpiece 110 of the assembled vaporization device 100. In one embodiment, the sensor 370 detect such a user draw and signals that power from the battery 140 to the plurality of coils 310 should be turned on. Similarly, when the sensor 370 no longer detects the user draw a signal is sent to turn off the power from the battery 140 to the plurality of coils 310.

Still referring to FIG. 6, a battery cap 380 is disposed on an end of the battery body 160 to close an open end of the battery body 160 and also to provide support for an electrode interface 390. The battery cap 380 may be fixed to the battery body 160, for example, by a press fit or a snap fit or by tabs received in recesses or by any method for attachment as may be known in the art. The electrode interface 390 provides access to charge the battery 140 from an external source. In one embodiment the electrode interface 390 is just an opening or openings that allow access for external pins on a charging device or plug to enter the battery body 160 through the battery cap 380 to contact internal pins that allow for charging of the battery 140. In other embodiments, the electrode interface 390 could be any sort of plugin port as known in the art, for example without limitation, a USB port, a mini-USB port, etc.

A second embodiment of a vaporization device 400 of the present invention is shown in FIGS. 7 and 8 and described more fully in FIGS. 9 and 10. The second embodiment of the vaporization device 400 is largely similar to the first embodiment of the vaporization device 100 except for some differences as explained hereinbelow. Therefore, the same reference numeral is used wherever the component being described is the same as in the first embodiment, but a different reference numeral is used for a different component.

Externally viewed, the vaporization device 400 comprises a mouthpiece 110 attached to an end of a body 420. The mouthpiece 110 includes an aperture 130 (see FIG. 9) therethrough for a user to draw on the vaporization device 400. The aperture 130 is fluidly connected to an interior volume of a vent tube 190 shown in FIGS. 9 and 10.

Referring to FIG. 9, in cross-section additional components of the second embodiment of the vaporization device 400 are visible. A first portion of the vaporization device 400 shown within the dashed ellipse 4 includes a first attachment region between the mouthpiece 110 and the tank body 150. This first portion of the second embodiment of the vaporization device 400 is identical to the first portion of the first embodiment of the vaporization device 100 described above with reference to FIG. 4.

Referring to FIGS. 9 and 10, the second portion of the vaporization device 400 shown within the dashed ellipse 10 in FIG. 9 shows the embodiments of the wick and coil assembly 230 shown in FIG. 3 and an end attachment region extending from the tank body 150. The second portion of the vaporization device 400 shown in FIG. 10 shows the embodiments of the wick and coil assembly 230 shown in FIG. 5 and an end attachment region extending from the tank body 150.

Still referring to FIGS. 9 and 10, the structure of the second portion of the vaporization device 400 is largely identical to that of the vaporization device 100 except that in this embodiment a battery body similar to the battery body 160 (except for not being permanently attached to the tank body 150) detachably attaches to a tank body 450, for example, via threads that engage with threads 455 shown in FIGS. 9 and 10. Though threads 455 are shown any suitable means of detachable attachment can be used, for example without limitation, a press fit, a snap fit, tabs received in recesses, or the like.

Those skilled in the art will appreciate that the invention described herein is susceptible to variations and modifications other than those specifically described, and that each embodiment is also provided with features that may be applicable to other embodiments. It is to be understood that the invention includes all such variations and modifications that fall within its spirit and scope. The invention also includes all the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### INDUSTRIAL APPLICABILITY

The vaporization device includes a wick and coil assembly comprising a plurality of coils disposed on an inner surface of an annular ceramic support member. Each of the plurality of coils has a different resistance and the plurality of coils is configured in an electrical circuit in parallel with a common voltage source. The vaporization device further includes an e-liquid reservoir comprising an annular configuration that narrows radially at a longitudinal end thereof to define an annular aperture that provides fluid communication between the reservoir and the wick and coil assembly. The vaporization device can be manufactured and used in industry.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

1. A vaporization device, comprising:
an e-liquid reservoir; and
a wick and coil assembly in fluid communication with the e-liquid reservoir, wherein the wick and coil assembly comprises:
an annular ceramic support member; and
one or more coils disposed on an inner surface of the annular ceramic support member;
wherein
the e-liquid reservoir comprises an annular configuration that narrows radially at a longitudinal end thereof to define an annular aperture disposed at the longitudinal end of the reservoir, wherein the annular aperture provides fluid communication between the reservoir and the annular ceramic support member.

2. (canceled)

3. (canceled)

4. (canceled)

5. The vaporization device of claim 1, wherein a layer of absorbent material is disposed between the annular aperture and the annular ceramic support member.

6. The vaporization device of claim 1, wherein the one or more coils comprises a plurality of coils, and each coil of the plurality of coils has a different electrical resistance.

7. The vaporization device of claim 6, wherein the plurality of coils is configured in an electrical circuit in parallel with a voltage source.

8. The vaporization device of claim 1, wherein the one or more coils comprises a plurality of coils, and each coil of the plurality of coils has a different wire radius.

9. The vaporization device of claim 1, wherein the one or more coils comprises a plurality of coils, and each coil of the plurality of coils has a different coil radius.

10. The vaporization device of claim 1 further comprising a mouthpiece attached to the vaporization device.

11. The vaporization device of claim 10, wherein the mouthpiece is detachably attached.

12. The vaporization device of claim 1, further comprising a battery body attached to the vaporization device.

13. The vaporization device of claim 12, wherein the battery body is detachably attached using a threaded connection.

14. A vaporization device, comprising:
a wick and coil assembly; and
an e-liquid reservoir comprising an annular configuration that narrows radially at a longitudinal end thereof to define an annular aperture disposed at the longitudinal end of the reservoir, wherein the annular aperture provides fluid communication between the reservoir and the wick and coil assembly.

15. The vaporization device of claim 14, wherein the wick and coil assembly comprises:
an annular ceramic support member; and
one or more coils disposed on an inner surface of the annular ceramic support member.

16. (canceled)

17. The vaporization device of claim 15, wherein a layer of absorbent material is disposed between the annular aperture and the annular ceramic support member.

18. A vaporization device, comprising:
a wick and coil assembly comprising:
an annular ceramic support member; and
a plurality of coils disposed on an inner surface of the annular ceramic support member; and
an e-liquid reservoir comprising an annular configuration that narrows radially at a longitudinal end thereof to define an annular aperture disposed at the longitudinal end of the reservoir, wherein the annular aperture provides fluid communication between the reservoir and the wick and coil assembly.

19. (canceled)

20. The vaporization device of claim 18, wherein each coil of the plurality of coils has a different electrical resistance, and the plurality of coils is configured in an electrical circuit in parallel with a voltage source.
